(19) United States
(12) Patent Application Publication
(10) Pub. No.: US 2012/0162284 A1
(43) Pub. Date: Jun. 28, 2012

(54) Signal processing device, signal processing method, display device, and electronic apparatus

(75) Inventors: Junichi Yamashita, Tokyo (JP); Katsuhide Uchino, Kanagawa (JP)

(73) Assignee: Sony Corporation, Tokyo (JP)

(21) Appl. No.: 13/317,368

(22) Filed: Oct. 17, 2011

(30) Foreign Application Priority Data
Dec. 28, 2010 (JP) 2010-291841

(51) Int. Cl. G09G 5/10

(52) U.S. Cl. 345/690

(57) ABSTRACT

A signal processing device includes a measuring unit, a conversion efficiency calculation unit, and a conversion efficient deterioration value calculation unit. The measuring unit outputs levels of driving signals having different magnitudes every update period to drive a pixel circuit and measures the luminance of the pixel circuit when driven accordingly. The conversion efficiency calculation unit calculates a conversion efficiency value of the pixel circuit based on the relationship between driving current value and luminance value. The conversion efficiency deterioration value calculation unit compares the conversion efficiency value of the pixel circuit with a conversion efficiency value of a correction reference state, calculates a conversion efficiency deterioration value corresponding to an elapsed time from the correction reference state, and updates luminance deterioration information with the conversion efficiency deterioration value.

### FIELD

The present disclosure relates to a signal processing device and method for outputting a driving signal to a pixel circuit having a light-emitting device, and a display device and an electronic apparatus each including the pixel circuit.

### BACKGROUND

A display device which includes a pixel unit in which a plurality of pixels are arranged in a matrix form and which controls the pixel unit in accordance with image information to be displayed to thereby display images is known. In recent years, a display device in which self-light-emitting devices (for example, organic EL (Electroluminescence) elements) are used in the pixel unit has attracted attention. In such a display device, pixel circuits including organic EL elements are arranged in a matrix form to form a display screen. However, since the organic EL element expresses a gradation by changing the amount of luminescence in accordance with image data to be displayed, the degree of deterioration of the organic EL element is different from one pixel circuit to another. Thus, with the elapse of time, a pixel in which the degree of deterioration is large and a pixel in which the degree of deterioration is small coexist on the display screen. In this case, a phenomenon (commonly known as burn-in) occurs in which a previously displayed image appears to remain on the display screen since the pixel in which the degree of deterioration is large becomes darker than the neighboring pixels.

In order to prevent such a burn-in phenomenon, a display device in which deterioration of a light-emitting device in which the degree of deterioration is small is caused to progress during a non-use period so that the degree of deterioration thereof becomes equal to that of a light-emitting device in which the degree of deterioration is large is proposed (for example, see JP-A-2008-176274).

### SUMMARY

However, in the display device in which deterioration of a light-emitting device in which the degree of deterioration is small is caused to progress during a non-use period so that the degree of deterioration thereof becomes equal to that of a light-emitting device in which the degree of deterioration is large, there is a possibility that determination of whole light-emitting devices is caused to progress. Moreover, since correction of burn-in is performed during the non-use period of the display device, there is another problem in that it is not possible to correct burn-in during the use of the display device. Therefore, a method of correcting burn-in by changing the gradation value of a video signal taking deterioration of a light-emitting device itself during the use of the display device into consideration may be considered.

For example, a method in which the gradation value of a video signal is designated in accordance with the degree of deterioration of a pixel circuit that displays the video signal, and a light-emitting device is caused to emit light using the changed video signal may be considered. For example, deterioration information in which a driving time of a general pixel circuit is correlated with the degree of deterioration of luminance may be stored in advance in a device, and the gradation value of a video signal may be changed in response to the elapse of the driving time and in accordance with the amount of deterioration of luminance of respective pixels, which is estimated based on the deterioration information. However, the degree of deterioration of pixels is different from one pixel circuit to another, and the video signal supplied to a pixel circuit is also different from one display target to another. Thus, it is not easy to perform burn-in correction with high accuracy using general deterioration information.

It is therefore desirable to provide a signal processing device and method capable of correcting burn-in with high accuracy by obtaining highly accurate deterioration information and a display device and an electronic apparatus each including the signal processing device.

An embodiment of the present disclosure is directed to a signal processing device that outputs a driving signal to a pixel circuit having a light-emitting device. The signal processing device includes a measuring unit, a conversion efficiency calculation unit, and a conversion efficiency deterioration value calculation unit. The measuring unit outputs a plurality of levels of driving signals having different magnitudes every prescribed update period to drive a prescribed pixel circuit with driving current values corresponding to the respective levels of driving signals. Moreover, the measuring unit measures the luminance of the prescribed pixel circuit when driven with each of the driving current values. The conversion efficiency calculation unit calculates a conversion efficiency value of the prescribed pixel circuit based on the relationship between a driving current value corresponding to the level of the driving signal and the luminance value of the prescribed pixel circuit. The conversion efficiency deterioration value calculation unit compares the conversion efficiency value of the prescribed pixel circuit with a conversion efficiency value when the prescribed pixel circuit is a correction reference state, and calculates a conversion efficiency deterioration value corresponding to an elapsed time from the time when the prescribed pixel circuit is in the correction reference state. Moreover, the conversion efficiency deterioration value calculation unit updates luminance deterioration information with the conversion efficiency deterioration value, the luminance deterioration information representing the relationship between the elapsed time from the time when the prescribed pixel circuit is in the correction reference state and the conversion efficiency deterioration value of the prescribed pixel circuit.

According to the signal processing device of the embodiment of the present disclosure, the measuring unit outputs a plurality of levels of driving signals having different magnitudes every prescribed update period to drive a prescribed pixel circuit with driving current values corresponding to the respective levels of driving signals. Moreover, the measuring unit measures the luminance of the prescribed pixel circuit when driven with each of the driving current values. In this way, it is possible to obtain measurement information including the driving current value corresponding to the level of the driving signal and the luminance value at that time. The conversion efficiency value calculation unit calculates a conversion efficiency value of the prescribed pixel circuit based on the relationship between the driving current value corresponding to the level of the driving signal and the luminance value of the prescribed pixel circuit. The conversion efficiency value is a value representing the luminance into which the driving current value is converted. The conversion efficiency value decreases as the deterioration of a pixel circuit progresses. In this case, it is possible to obtain the conversion efficiency value of the prescribed pixel circuit from the measurement values obtained with the plurality of levels of driving signals every prescribed update period. In this way, it is possible to extract a conversion efficiency component and to obtain an accurate conversion efficiency value. The conversion efficiency deterioration value calculation unit calculates the conversion efficiency value of the prescribed pixel circuit by calculating a conversion efficiency deterioration value corresponding to an elapsed time from the time when the prescribed pixel circuit is in the correction reference state. Moreover, the conversion efficiency deterioration value calculation unit updates luminance deterioration information with the conversion efficiency deterioration value, the luminance deterioration information representing the relationship between the elapsed time from the time when the prescribed pixel circuit is in the correction reference state and the conversion efficiency deterioration value of the prescribed pixel circuit. In this way, it is possible to obtain the luminance deterioration information in which the actual measurement values are taken into consideration.

Another embodiment of the present disclosure is directed to a signal processing method, a display device, and an electronic apparatus which perform the same signal processing as the signal processing device described above.

According to the signal processing device, the signal processing method, the display device, and the electronic apparatus of the embodiment of the present disclosure, the luminance deterioration information regarding the conversion efficiency deterioration of a pixel circuit is generated based on the measurement information measured using an actual pixel circuit. In this case, by calculating the conversion efficiency deterioration using the measurement information measured with a plurality of levels of driving signals, it is possible to obtain an accurate conversion efficiency deterioration value. Moreover, by performing burn-in correction based on the accurate conversion efficiency deterioration value, it is possible to perform the burn-in correction with high accuracy.

### BRIEF DESCRIPTION OF THE DRAWINGS

FIG. 1 is a conceptual diagram showing a configuration example of a display device according to an embodiment of the present disclosure.

FIG. 2 is a circuit diagram schematically showing a configuration example of a pixel circuit.

FIG. 3 is a graph showing an example of a change in luminance with the elapse of time, of a pixel circuit.

FIG. 4 is a graph showing the relationship between a gradation value of a video signal and a luminance value.

FIG. 5 is diagram showing an example of a hardware configuration of a burn-in correction unit.

FIG. 6 is a diagram showing an example of a functional configuration of the burn-in correction unit.

FIG. 7 is a diagram showing a generation example of luminance deterioration information by a luminance deterioration information generation unit.

FIG. 8 is a graph showing an example of a pixel characteristic based on measurement information.

FIG. 9 is a graph showing an example of a luminance deterioration curve based on luminance deterioration information.

FIG. 10 is a diagram showing a generation example of a conversion efficiency deterioration correction pattern.

FIG. 11 is a flowchart showing an example of the procedure of a luminance deterioration information generation process.

FIG. 12 is a perspective view showing a television set including the display device according to the embodiment of the present disclosure.

FIG. 13 is a perspective view showing a digital still camera including the display device according to the embodiment of the present disclosure.

FIG. 14 is a perspective view showing a notebook personal computer including the display device according to the embodiment of the present disclosure.

FIG. 15 is a schematic diagram showing portable terminal including the display device according to the embodiment of the present disclosure.

FIG. 16 is a perspective view showing a video camera including the display device according to the embodiment of the present disclosure.

### DETAILED DESCRIPTION

Hereinafter, embodiments of the present disclosure will be described with reference to drawings.

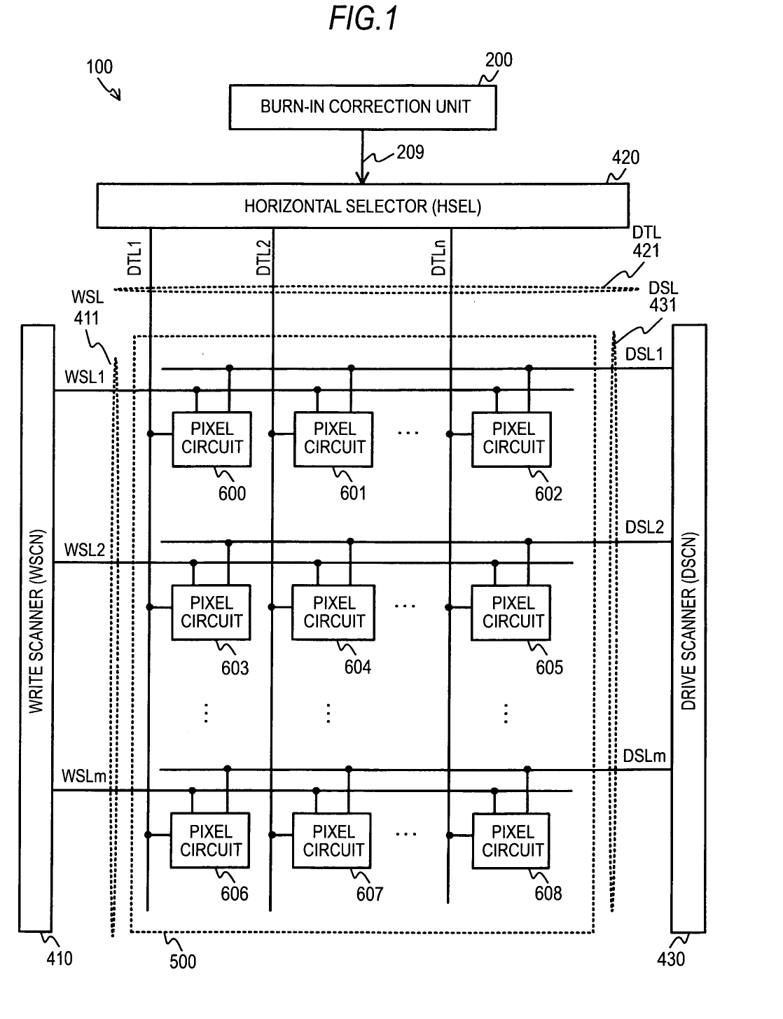

FIG. 1 is a conceptual diagram showing a configuration example of a display device according to an embodiment of the present disclosure. A display device 100 includes a burn-in correction unit 200, a write scanner (WSCN: Write SCaNner) 410, a horizontal selector (HSEL: Horizontal SELector) 420, a drive scanner (DSCN: Drive SCaNner) 430, and a pixel array unit 500.

The pixel array unit 500 includes n×m pixel circuits 600 to 608 (where n and m are integers of 2 or more) which are arranged in a 2-dimensional matrix form. For the sake of convenience, nine pixel circuits 600 to 608 disposed on the first, second, and n-th columns of the first, second, and m-th rows are shown in FIG. 1. The pixel circuits 600 to 608 are connected to the write scanner (WSCN) 410 through scan lines (WSL: Write Scan Line) 411, respectively. Moreover, the pixel circuits 600 to 608 are connected to the horizontal selector (HSEL) 420 through data lines (DTL: DaTa Line) 421, respectively, and to the drive scanner (DSCN) 430 through drive lines (DSL: Drive Scan Line) 431, respectively. In FIG. 1, for the sake of convenience, the numbers of columns (1, . . . , and n) and rows (1, . . . , and m) of connected pixel circuits are assigned to the scan lines (WSL) 411, the data lines (DTL) 421, and the drive lines (DSL) 431. For example, a scan line WSL1, a data line DTL1, and a drive line DSL1 are connected to a pixel circuit 600 disposed on the first column of the first row.

The burn-in correction unit 200 is a signal processing circuit which receives the gradation value of a video signal and corrects burn-in by changing the gradation value of the video signal in accordance with the degree of deterioration of each of the pixel circuits 600 to 608. The burn-in correction unit 200 may be configured as a signal processing device. Here, the gradation value is a driving signal for instructing the pixel circuits 600 to 608 to be driven so as to emit light at a prescribed luminance, and designates the level (step) representing the degree of light emission. For example, the magnitude of emission luminance can be expressed in 256 levels (gradations). It is assumed that emission luminance increases as the signal level of the gradation value increases. Here, a gradation value of a video signal of which the emission luminance is 200 nit when the pixel circuit 600 is in the initial state is referred to as a “gradation value 200”. It is assumed that after the elapse of a prescribed period, due to deterioration of the pixel circuit 600, it is possible to obtain an emission luminance of 100 nit even when “gradation value 200” is output. Similarly, it is assumed that the emission luminance as of “gradation value 300” has been deteriorated to 200 nit from 300 nit of the initial state. In this case, the burn-in correction unit 200 changes the gradation value of an output video signal to “gradation value 400”, for example, in order to obtain the luminance (200 nit) of the initial state of “gradation value 200”. The burn-in correction unit 200 supplies the changed video signal to the horizontal selector (HSEL) 420 through a signal line 209. In this way, the pixel circuit 600 is caused to emit light at a luminance of 200 nit to thereby be able to correct burn-in.

The write scanner (WSCN) 410 performs line-sequential scanning wherein the pixel circuits 600 to 608 are sequentially scanned in units of rows. The horizontal selector (HSEL) 420 supplies data signal for setting the magnitude of emission luminance in the pixel circuits 600 to 608 to the pixel circuits 600 to 608 of respective columns in accordance with the line-sequential scanning by the write scanner (WSCN) 410. The drive scanner (DSCN) 430 generates a drive signal for driving the pixel circuits 600 to 608 in units of rows in accordance with the line-sequential scanning by the write scanner (WSCN) 410. Moreover, the pixel circuits 600 to 608 hold the potential of the video signal from the data lines (DTL) 421 based on an operation signal from the scanning lines (WSL) 411 and emit light for a prescribed period in accordance with the held potential.

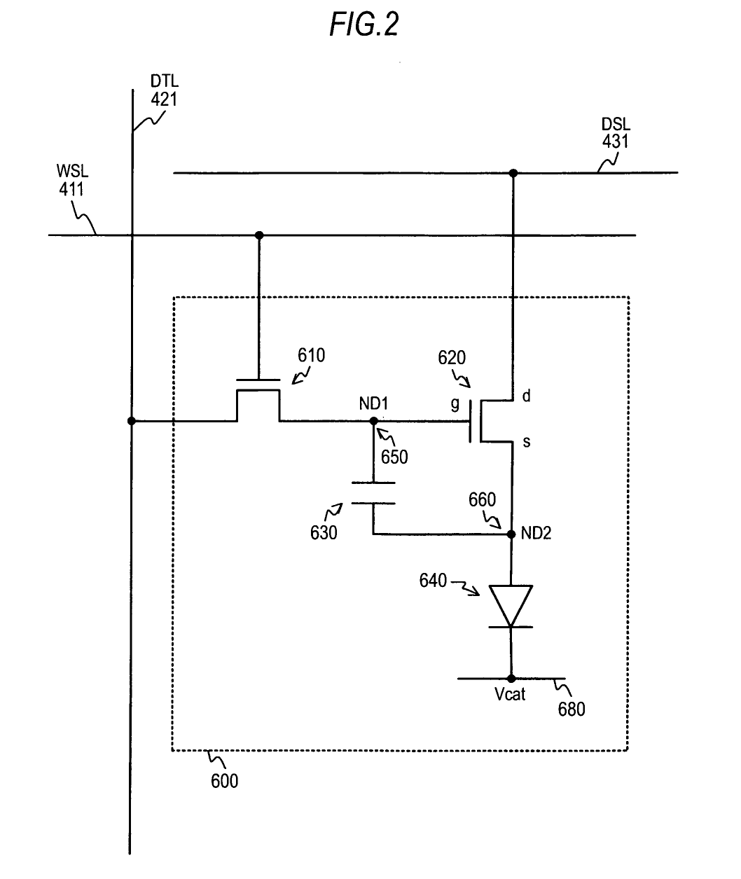

FIG. 2 is a circuit diagram schematically showing a configuration example of a pixel circuit. Although FIG. 2 shows the pixel circuit 600, the other pixel circuits have the same configuration.

The pixel circuit 600 includes a writing transistor 610, a driving transistor 620, a hold capacitor 630, and a light-emitting device 640. In the example of FIG. 2, it is assumed that the writing transistor 610 and the driving transistor 620 are n-channel transistors. In addition, the writing transistor 610 and the driving transistor 620 are not limited to this combination. For example, the transistors 610 and 620 may be p-channel transistors, and may be enhancement, depletion, or dual-gate type transistors.

In the pixel circuit 600, the gate and drain terminal s of the writing transistor 610 are connected to the scanning line (WSL) 411 and the data line (DTL) 421, respectively. Moreover, the source terminal of the writing transistor 610 is connected to the gate terminal (g) of the driving transistor 620 and one electrode (one end) of the hold capacitor 630. In FIG. 2, this connection node is referred to as a first node (ND1) 650. Moreover, the drain terminal (d) of the driving transistor 620 is connected to the drive line (DSL) 431. The source terminal (s) of the driving transistor 620 is connected to the other electrode (the other end) of the hold capacitor 630 and the anode terminal of the light-emitting device 640. In FIG. 2, this connection node is referred to as a second node (ND2) 660.

The writing transistor 610 is a transistor that supplies a data signal from the data line (DTL) 431 to the first node (ND1) 650 in accordance with the scanning signal from the scanning line (WSL) 411. The writing transistor 610 supplies a reference potential of a data signal to one end of the hold capacitor 630 in order to eliminate unevenness in the threshold of the driving transistor 620 of the pixel circuit 600. The reference potential mentioned herein is a fixed potential serving as a reference for causing the hold capacitor 630 to hold a voltage corresponding to the threshold voltage of the driving transistor 620. Moreover, the writing transistor 610 sequentially writes a signal potential of the data signal to one end of the hold capacitor 630 after the voltage corresponding to the threshold voltage of the driving transistor 620 is held in the hold capacitor 630.

The driving transistor 620 outputs a driving current to the light-emitting device 640 based on a signal voltage held in the hold capacitor 630 in accordance with the signal potential in order to cause the light-emitting device 640 to emit light. The driving transistor 620 outputs a driving current corresponding to the signal voltage held in the hold capacitor 630 to the light-emitting device 640 in a state where a driving potential for driving the driving transistor 620 is applied from the drive line (DSL) 431.

The hold capacitor 630 holds a voltage corresponding to the data signal supplied by the writing transistor 610. That is, the hold capacitor 630 performs a role of holding a signal voltage corresponding to the signal potential written by the writing transistor 610.

The light-emitting device 640 emits light in accordance with the magnitude of the driving current output from the driving transistor 620. Moreover, the light-emitting device 640 has an output terminal connected to a cathode line 680. From the cathode line 680, a cathode potential (Vcat) is supplied as a reference potential of the light-emitting device 640. The light-emitting device 640 can be realized by an organic EL element, for example.

In addition, the configuration of the pixel circuit 600 is not limited to the circuit configuration shown in FIG. 2. That is, any circuit configuration which includes the driving transistor 620 and the light-emitting device 640 can be applied to the pixel circuit 600. For example, light emission may be controlled with three or more transistors.

As described above, in the pixel circuit 600 of the display device 100, a driving current corresponding to the signal potential supplied through the data line (DTL) 421 is supplied to the light-emitting device 640, whereby the light-emitting device 640 emits light at a luminance corresponding to the driving current. Thus, when the driving transistor 620, the light-emitting device 640, or the like, which constitute the pixel circuit 600 deteriorates, the amount of the driving current or the amount of emission light changes. As a result, the value of luminance corresponding to a signal potential will be shifted from that of the initial state. If the same amount of shift occurs in all pixel circuits, a so-called burn-in phenomenon will not be caused. However, since an organic EL element expresses a gradation by changing the amount of emission light in accordance with image data to be displayed, the degree of deterioration of the organic EL element is different from one pixel circuit on the display screen to another. Thus, the burn-in phenomenon occurs since a pixel circuit in which the degree of deterioration is large becomes darker than the neighboring pixel circuits.

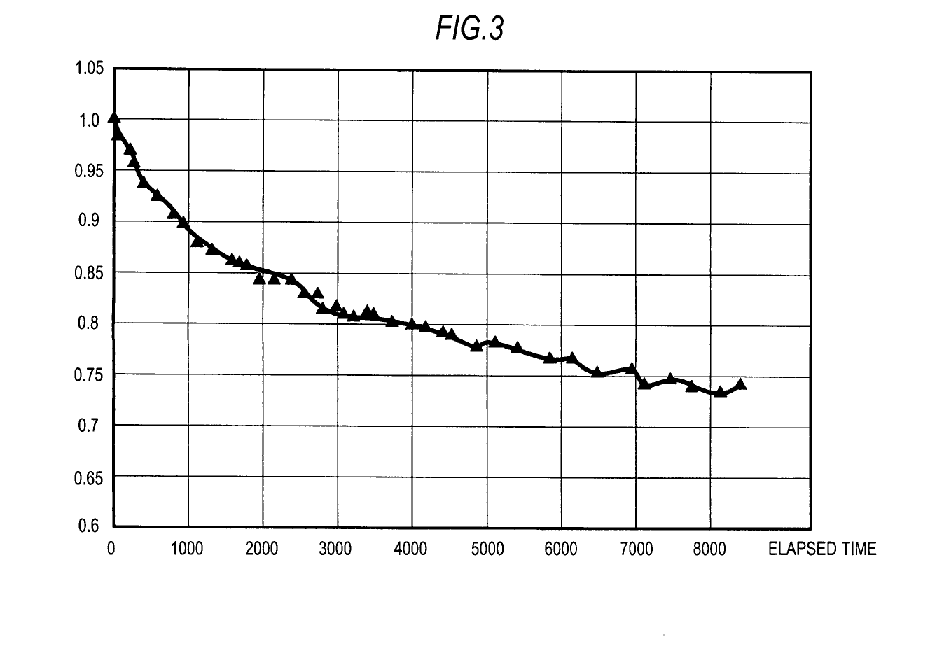

FIG. 3 is a graph showing an example of a change in luminance with the elapse of time, of a pixel circuit. FIG. 3 shows a change in the value (luminance value) of emission luminance with the elapse of time when in a pixel circuit having an organic EL element as a light-emitting device, the light-emitting device 640 is driven in response to a gradation value for emitting light at a luminance of 200 nit. The horizontal axis of FIG. 3 represents the elapsed time accumulated from the initial state. The vertical axis of FIG. 3 represents the ratio of time-varying luminance with the elapse of time to a reference luminance “200 nit” as a correction reference. Here, the initial state means a state when a target pixel circuit is in a correction reference state, and the elapsed time is set to “0” when the target pixel circuit is in the initial state. In the initial state where the elapsed time is “0”, the ratio of the time-varying luminance to the reference luminance is “1.0”. That is, the time-varying luminance is 200 nit in the initial state. It can be understood from FIG. 3 that the luminance decreases as the driving time of the pixel circuit elapses. For example, when a period of 4000 hours elapses, the luminance obtained when the same gradation value as the initial state is output to the pixel circuit is “0.8” of that of the initial state, namely 160 nit. Thus, in order to obtain a luminance of 200 nit with the pixel circuit after the elapse of 4000 hours, a correction process of adding a correction amount corresponding to a luminance deterioration amount to the gradation value of a video signal may be performed. In this way, the pixel circuit will be able to emit light at an apparent luminance of 200 nit.

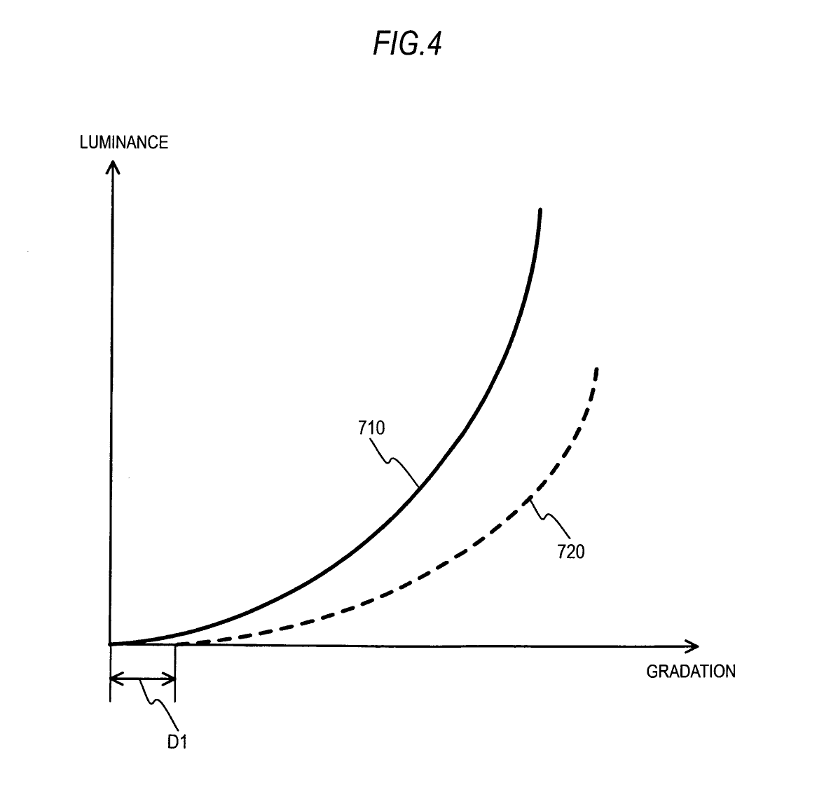

FIG. 4 is a graph showing the relationship between a gradation value of a video signal and a luminance value. The horizontal axis of FIG. 4 represents the gradation value of a video signal input to the burn-in correction unit 200, and the vertical axis represents the luminance values obtained in the pixel circuits 600 to 608. Moreover, a pixel characteristic curve (initial) 710 represents the relationship between an input gradation value and a luminance value in a pixel circuit in the initial state, and a pixel characteristic curve (deterioration target) 720 represents the relationship between an input gradation value and a luminance value in a pixel circuit after the elapse of time from the initial state.

The pixel characteristic curve (initial) 710 will be described. The pixel characteristic curve (initial) 710 is expressed by the following quadratic function, for example.

L=A×S² (1)

Here, “L” is a luminance value. Moreover, “A” is a coefficient (efficiency coefficient) determined based on conversion efficiency of the light-emitting device 640. Furthermore, “S²” is a value calculated using the square characteristics of the driving transistor 620 and is a value corresponding to the driving current supplied to the light-emitting device 640. As above, the luminance value L can be calculated based on the efficiency coefficient A of the light-emitting device 640 and the driving current S².

The pixel characteristic curve (correction target) 720 has a gentler slope than the pixel characteristic curve (initial) 710 since the light-emitting device 640 deteriorates with the elapse of time, and the conversion efficiency of converting a driving current to a luminance deteriorates. Moreover, the pixel characteristic curve (correction target) 720 is shifted rightward by an amount corresponding to a driving current amount decrease component D1 in the horizontal axis direction as compared to the pixel characteristic curve (initial) 710. The driving current amount decrease component D1 is a component indicating the amount (driving current decrease amount) of decrease in the driving current and occurs due to deterioration of the driving transistor 620 and the light-emitting device 640. That is, in the pixel characteristic curve (initial) 710 expressed by Equation (1), the pixel characteristic curve (correction target) 720 in a state where the driving transistor 620 and the light-emitting device 640 deteriorate is expressed by the following quadratic function.

Ld=Ad×(S−ΔS)² (2)

Here, “Ld” is the luminance value of a pixel circuit serving as a correction target. Moreover, “Ad” is a coefficient (efficiency coefficient) determined based on the conversion efficiency of the light-emitting device 640 of a pixel circuit serving as a correction target. Furthermore, “ΔS” is the driving current amount decrease component D1. Furthermore, “(S−ΔS)²” represents a driving current supplied to the light-emitting device 640 when the driving current amount decrease component D1 is taken into consideration. As above, the deteriorated luminance value Ld can be calculated by the driving current (S−ΔS)² in which the deteriorated efficiency coefficient Ad and the driving current amount decrease component D1 are taken into consideration.

As described above, when a pixel circuit deteriorates with the use of the display device 100, deterioration of a conversion efficiency and decrease of a driving current progress at the same time, and a luminance value corresponding to the gradation value of a video signal decreases. In addition, the conversion efficiency deterioration corresponds to a decrease in slope of the pixel characteristic curve, and the decrease of the driving current corresponds to a shift of the gradation of the pixel characteristic curve.

The burn-in correction unit 200 of the display device 100 uses the pixel characteristic curve (initial) 710 in a correction reference state as a reference and corrects an input gradation value so that the pixel characteristic curve (correction target) 720 of a deteriorated pixel circuit is identical to the reference (the pixel characteristic curve 710). Although details are described later, the burn-in correction unit 200 prepares a conversion efficiency deterioration correction pattern for correcting a conversion efficiency deterioration and a current amount deterioration correction pattern for correcting a driving current amount deterioration (current deterioration) and corrects the gradation value of a video signal of a deteriorated pixel circuit.

Here, correction of a conversion efficiency deterioration component will be described. In correction of the conversion efficiency deterioration component, the gradation of a video signal is changed based on the following expression. A corrected gradation value Sout is calculated by the following equation based on Equations (1) and (2).

Sout=(ΔA)^{-1/2}×Sin (3)

ΔA=Ad/A (4)

Here, “Sin” is a gradation value of a video signal before corrected by the burn-in correction unit 200. Moreover, “ΔA” is the value (conversion efficiency deterioration value) of a fraction expressing the ratio of conversion efficiencies in which the conversion efficiency Ad of a correction target pixel circuit is the numerator and the conversion efficiency A of a pixel circuit in the initial state is the denominator.

However, although the efficiency coefficient A in the initial state can be known by the specification values of a device or measurement during shipment, the efficiency coefficient Ad of the pixel circuit during operation cannot be measured actually. Thus, the correlation between the elapsed time from the initial state of a pixel circuit which is continuously operated with a prescribed gradation value and a conversion efficiency deterioration value is held in advance in the burn-in correction unit 200 as luminance deterioration information. Then, the efficiency coefficient Ad of each pixel circuit is estimated based on the luminance deterioration information, and a correction amount is calculated. However, since the degree of deterioration of a pixel circuit is different depending on the operation environment thereof, it is difficult to perform correction with high accuracy with typical luminance deterioration information which is set in advance. Therefore, the burn-in correction unit 200 of the display device 100 according to the embodiment actually measures the degree of deterioration of a pixel circuit and updates the luminance deterioration information in accordance with the measurement results to thereby increase the accuracy of the burn-in correction.

### [Configuration Example of Burn-in Correction Unit]

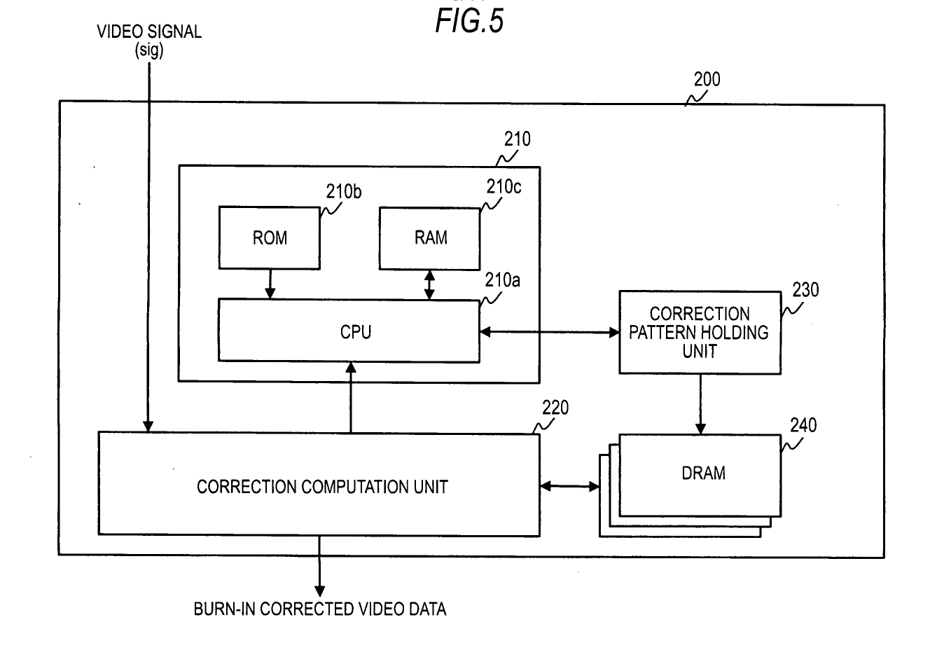

First, a hardware configuration example of the burn-in correction unit 200 will be described. FIG. 5 is a diagram showing an example of a hardware configuration of the burn-in correction unit.

The burn-in correction unit 200 includes a correction pattern generation unit 210, a correction computation unit 220, a correction pattern holding unit 230, and a DRAM (Dynamic Random Access Memory) 240. The burn-in correction unit 200 corrects the gradation value of an input video signal and outputs the corrected video signal to the pixel array unit 500 as burn-in correction video data.

The correction pattern generation unit 210 performs a process of generating correction patterns for correcting conversion efficiency deterioration and current amount deterioration with the aid of a CPU (Central Processing Unit) 210a. The CPU 210a is connected through an internal bus to a ROM (Read Only Memory) 210b, a RAM (Random Access Memory) 210c, and peripheral devices such as the correction computation unit 220 and the correction pattern holding unit 230.

Various data necessary for processing by the CPU 210a are stored in the RAM 210c. OS programs, application programs, and various data are stored in the ROM 210b.

The correction computation unit 220 acquires the gradation value of a video signal and performs a burn-in correction process. The correction computation unit 220 is configured by an ASIC (Application Specific Integrated Circuit) or an FPGA (Field Programmable Gate Array) in order to perform processing at a high speed.

The correction pattern holding unit 230 is a storage unit that holds correction patterns generated by the correction pattern generation unit 210. For example, the correction pattern holding unit 230 is configured by a semiconductor storage device such as a flash memory.

The DRAM 240 is a storage unit that holds correction patterns which are referenced by the correction computation unit 220. For example, the DRAM 240 is configured by a memory capable of performing processing at a relatively high speed such as a DDR SDRAM (Double-Data-Rate Synchronous DRAM).

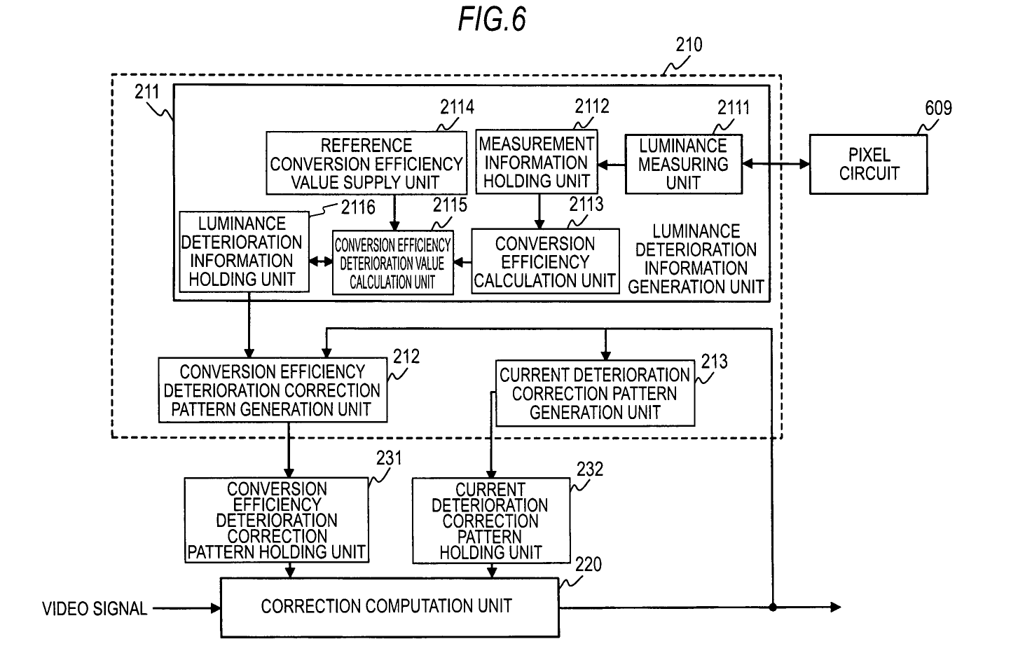

Next, a functional configuration example of the burn-in correction unit 200 will be described. FIG. 6 is a diagram showing an example of a functional configuration of the burn-in correction unit.

The burn-in correction unit 200 includes a correction pattern generation unit 210, a correction computation unit 220, a conversion efficiency deterioration correction pattern holding unit 231, and a current deterioration correction pattern holding unit 232. The correction pattern generation unit 210 includes a luminance deterioration information generation unit 211, a conversion efficiency deterioration correction pattern generation unit 212, and a current deterioration correction pattern generation unit 213.

The luminance deterioration information generation unit 211 includes a luminance measuring unit 2111, a measurement information holding unit 2112, a conversion efficiency calculation unit 2113, a reference conversion efficiency value supplying unit 2114, a conversion efficiency deterioration value calculation unit 2115, and a luminance deterioration information holding unit 2116. The luminance deterioration information generation unit 211 updates luminance deterioration information based on the luminance value obtained from the pixel circuit 609.

The luminance measuring unit 2111 is activated every prescribed update period corresponding to an update cycle for updating the luminance deterioration information of a prescribed pixel circuit 609. When the update period has been reached, the luminance measuring unit 2111 outputs a plurality of different levels of driving signals to a prescribed pixel circuit 609 of the display device 100 and measures the luminance of the pixel circuit 609 at each level of the driving signals. For example, the luminance measuring unit 2111 outputs driving signals corresponding to a plurality of levels of prescribed gradation values to the pixel circuit 609 and measures the luminance at that time. In this way, a set of a driving current and a luminance value corresponding to each of the plurality of levels of gradation values is obtained as measurement data. In addition, the driving current value at that time does not include a decrease component of the driving current due to deterioration of the pixel circuit 609. The driving current value corresponds to a driving current which is considered to flow through the pixel circuit 609 in a correction reference state when the gradation value is output thereto. Moreover, instead of the driving current value, measurement data in which the gradation value and the luminance value are correlated with each other may be acquired. The update cycle of the luminance deterioration information may be set to an optional period. For example, since the deterioration of the pixel circuit 609 progresses slowly, in order to alleviate the load applied to the burn-in correction unit 200, the update cycle may be set to a period longer than the processing cycle of a conversion efficiency deterioration correction pattern generation process. Although the target pixel circuit 609 is a pixel circuit included in the pixel array unit 500, a dummy pixel circuit which is not included in the display screen is used. By using the dummy pixel circuit, it is possible to perform a measurement process without affecting the display screen even when the display device 100 is under operation. Moreover, when performing inspection, adjustment, or the like before shipment, pixel circuits constituting the display screen may be used as target pixel circuits, and the characteristics for each pixel circuit may be acquired. In the luminance measuring unit 2111, a plurality of levels of driving signals, for example, a plurality of levels of gradation values is determined in advance. When the update period for the luminance deterioration information occurs, the luminance measuring unit 2111 sequentially outputs a designated gradation value to the pixel circuit 609 and measures the luminance value at that time. The measured luminance value is supplied to the measurement information holding unit 2112 so as to be correlated with the driving current value or the gradation value. In addition, in a period other than the measurement period, a prescribed gradation value is continuously output to the pixel circuit 609. For example, when calculating the luminance deterioration information for 200 nit, the pixel circuit 609 is caused to emit light with a gradation value corresponding to 200 nit excluding the measurement period. In this way, it is possible to obtain the luminance deterioration information for 200 nit using the pixel circuit 609.

The measurement information holding unit 2112 holds the driving current value or the gradation value output to the pixel circuit 609 and the driving current value at that time or the measurement value (luminance value) of the luminance of the light-emitting device 640 at that gradation value, supplied from the luminance measuring unit 2111 as measurement information. In the following description, the set of the plurality of levels of driving current values and luminance values will be referred to as the measurement information. The measurement information holding unit 2112 supplies the measurement information held therein to the conversion efficiency calculation unit 2113.

The conversion efficiency calculation unit 2113 calculates the efficiency coefficient of the pixel circuit 609 as a conversion efficiency value based on the luminance values measured with the plurality of levels of gradation values or driving current values by the luminance measuring unit 2111. As shown in Equation (2), the efficiency coefficient Ad of a deteriorated pixel circuit can be calculated by the driving current (S−ΔS)² in which the luminance value Ld of the pixel circuit and the driving current amount decrease component D1 are taken into consideration. However, the driving current amount decrease component D1 cannot be measured. Thus, the driving current value corresponding to the luminance value measured by the luminance measuring unit 2111 is a driving current value corresponding to a prescribed gradation value, namely a driving current value in which the driving current amount decrease component is not taken into consideration. Thus, even when the conversion efficiency is calculated by a division in which the measured luminance value Ld is a nominator, and the driving current value is a denominator, it is not possible to obtain an accurate efficiency coefficient Ad. Thus, a conversion efficiency value is calculated using driving current values measured at a plurality of levels and the luminance values corresponding to the deviation correction section. For example, the slope of a luminance value variation in relation to a driving current value variation (namely, “luminance value variation”/“driving current value variation”) is calculated based on the variation of driving current values between plural levels and the variation of the corresponding luminance values. The conversion efficiency value calculated in this way does not include the effect of the driving current amount decrease component D1, and a highly accurate conversion efficiency value can be obtained. The calculated conversion efficiency value is supplied to the conversion efficiency deterioration value calculation unit 2115.

The reference conversion efficiency value supplying unit 2114 supplies the conversion efficiency value of the pixel circuit serving as the reference for correction of the conversion efficiency deterioration to the conversion efficiency deterioration value calculation unit 2115. For example, the reference conversion efficiency value supplying unit 2114 holds the conversion efficiency value of the pixel circuit 609 in the initial state where no deterioration occurs and supplies the conversion efficiency value held therein as a reference conversion efficiency value.

The conversion efficiency deterioration value calculation unit 2115 calculates a conversion efficiency deterioration value based on the conversion efficiency value of the pixel circuit 609 during measurement, supplied from the conversion efficiency calculation unit 2113 and the reference conversion efficiency value supplied from the reference conversion efficiency value supplying unit 2114. For example, the conversion efficiency deterioration value calculation unit 2115 calculates the conversion efficiency deterioration value (ΔA) based on Equation (4). The ratio of conversion efficiencies in which the conversion efficiency value of a correction target pixel circuit is the numerator, and the conversion efficiency value of the pixel circuit in the correction reference state is calculated. Moreover, the luminance deterioration information is updated based on the calculated conversion efficiency deterioration value and the elapsed time from the correction reference state during measurement. The luminance deterioration information represents the relationship between the elapsed time from the correction reference state at a prescribed luminance and the conversion efficiency deterioration value. For example, a conversion efficiency deterioration value corresponding to the corresponding elapsed time in the luminance deterioration information is replaced with the presently calculated conversion efficiency deterioration value. Moreover, the luminance deterioration curve representing the correlation between the elapsed time and the conversion efficiency deterioration value may be updated in accordance with the acquired conversion efficiency deterioration value, and the luminance deterioration information may be updated in accordance with the updated luminance deterioration curve. The updated luminance deterioration information is supplied to the luminance deterioration information holding unit 2116.

The luminance deterioration information holding unit 2116 holds the luminance deterioration information updated by the conversion efficiency deterioration value calculation unit 2115. For example, the luminance deterioration information is held in the luminance deterioration information holding unit 2116 as luminance deterioration information having a table format in which the elapsed time from the correction reference state at a prescribed luminance is correlated with a conversion efficiency deterioration value at that elapsed time. The format of the luminance deterioration information may be an optional format. Moreover, since the degree of deterioration of a luminance is different depending on the luminance at which the pixel circuit emits light, the luminance deterioration information on a plurality of levels of luminance may be prepared. Alternatively, luminance deterioration information on one luminance may be held as master information, and conversion efficiency deterioration values at other luminance values may be calculated based on the master information. Since the proportion of luminance deterioration is the same for different luminance values, when the master information on one luminance is prepared, it is possible to calculate the conversion efficiency deterioration values at other luminance values.

As above, by measuring the deterioration of the pixel circuit 609 that is actually mounted on the display device 100 and generating the luminance deterioration information, it is possible to obtain the luminance deterioration information taking the actual state of the display device 100 into consideration. Moreover, when the efficiency coefficient based on the luminance deterioration information is used, it is possible to correct the deterioration of the conversion efficiency with high accuracy as compared to using the efficiency coefficient held in advance.

The conversion efficiency deterioration correction pattern generation unit 212 generates a pattern (conversion efficiency deterioration correction pattern) for correcting the conversion efficiency deterioration. The conversion efficiency deterioration correction pattern is a correction pattern including a correction value (conversion efficiency deterioration value) of the conversion efficiency deterioration for each of the pixel circuits 600 to 608 and is correction information for correcting the conversion efficiency deterioration. For example, the conversion efficiency deterioration value is the value of the slope of the pixel characteristic curve (correction target) 720 to the pixel characteristic curve (initial) 710 shown in FIG. 4. Although the details thereof are described later, the conversion efficiency deterioration correction pattern generation unit 212 holds the conversion efficiency deterioration information of the respective pixel circuits constituting the pixel array unit 500 and calculates the conversion efficiency deterioration values of the respective pixel circuits every prescribed period. In this case, the conversion efficiency deterioration correction pattern generation unit 212 refers to the luminance deterioration information of the pixel circuit 609 held in the luminance deterioration information holding unit 2116 in order to calculate the conversion efficiency deterioration values of the respective pixel circuits. The pixel circuit 609 is operating under the same operation environment as the display pixel circuits 600 to 608. Thus, it can be considered that the relationship between the elapsed time from the start of driving of the pixel circuit 609 and the conversion efficiency deterioration value has correlation with the relationship between the elapsed time and the conversion efficiency deterioration values of the pixel circuits 600 to 608. Thus, the conversion efficiency deterioration values of the pixel circuits 600 to 608 are calculated based on the luminance deterioration information at a prescribed gradation value, measured using the pixel circuit 609. The calculated conversion efficiency deterioration values of the respective pixel circuits are supplied to the conversion efficiency deterioration correction pattern holding unit 231.

The current deterioration correction pattern generation unit 213 generates a pattern (current deterioration correction pattern) for correcting the driving current decrease amount. The current deterioration correction pattern is a correction pattern including the correction value (current amount deterioration value) of the driving current decrease amount of each of the pixel circuits 600 to 608, and is correction information for correcting the driving current decrease amount. For example, the current amount deterioration value is the value of the driving current amount decrease component D1 shown in FIG. 4 as for the burn-in correction unit 200 that regards the pixel circuit in the initial state as the correction reference state. The current deterioration correction pattern generation unit 213 holds the current amount deterioration information of the respective pixel circuits constituting the pixel array unit 500 and calculates and integrates the new decrease amounts of the driving current of the respective pixel circuits every prescribed periods to thereby update the current amount deterioration information. For example, the current deterioration correction pattern generation unit 213 calculates information on the new decrease amounts of the pixel circuits 600 to 608 using a decrease amount coefficient based on the corrected video signal supplied from the correction computation unit 220. Here, the decrease amount coefficient is a coefficient for calculating the decrease amount of a driving current with the elapse of time, for example, and is held in advance. Moreover, the decrease amount coefficient may be appropriately updated based on the measurement information measured by the luminance measuring unit 2111.

The conversion efficiency deterioration correction pattern holding unit 231 and the current deterioration correction pattern holding unit 232 are included in the correction pattern holding unit 230. The conversion efficiency deterioration correction pattern holding unit 231 holds, for each pixel circuit, the conversion efficiency deterioration value supplied from the conversion efficiency deterioration correction pattern generation unit 212. In the following description, a conversion efficiency deterioration value group including the conversion efficiency deterioration values of the respective pixel circuits will be referred to as a conversion efficiency deterioration correction pattern. The conversion efficiency deterioration correction pattern holding unit 231 supplies the conversion efficiency deterioration correction pattern held therein to the correction computation unit 220. The current deterioration correction pattern holding unit 232 holds, for each pixel circuit, the current amount deterioration value supplied from the current deterioration correction pattern generation unit 213. In the following description, a current amount deterioration value group including the current amount deterioration values of the respective pixel circuits will be referred to as a current deterioration correction pattern. The current deterioration correction pattern holding unit 232 supplies the current deterioration correction pattern held therein to the correction computation unit 220.

The correction computation unit 220 corrects an input video signal and supplies the corrected video signal to the conversion efficiency deterioration correction pattern generation unit 212 and the current deterioration correction pattern generation unit 213 and to the horizontal selector (HSEL) 420 through the signal line 209. The correction computation unit 220 performs a conversion efficiency deterioration correction process for correcting the conversion efficiency deterioration and a current deterioration correction process for correcting the current deterioration. In the conversion efficiency deterioration correction process, the conversion efficiency deterioration is corrected by changing the gradation value of an input video signal based on the conversion efficiency deterioration correction pattern supplied from the conversion efficiency deterioration correction pattern holding unit 231. The gradation value of the video signal which has been subjected to the conversion efficiency deterioration correction is then subjected to the current deterioration correction process. In the current deterioration correction process, the current deterioration is corrected by changing the gradation value of the video signal which has been subjected to the conversion efficiency deterioration correction based on the current deterioration correction pattern supplied from the current deterioration correction pattern holding unit 232. The corrected gradation value of the video signal is supplied to the conversion efficiency deterioration correction pattern generation unit 212 and the current deterioration correction pattern generation unit 213 and to the horizontal selector (HSEL) 420 through the signal line 209.

As above, by providing the luminance deterioration information generation unit 211 in the burn-in correction unit 200, it is possible to correct the deterioration of the luminance value in the pixel circuits 600 to 608 with high accuracy.

Next, a generation example of the luminance deterioration information by the luminance deterioration information generation unit 211 will be described with reference to drawings. In the following description, the correction reference state will be referred to as the initial state.

### [Generation Example of Luminance Deterioration Information]

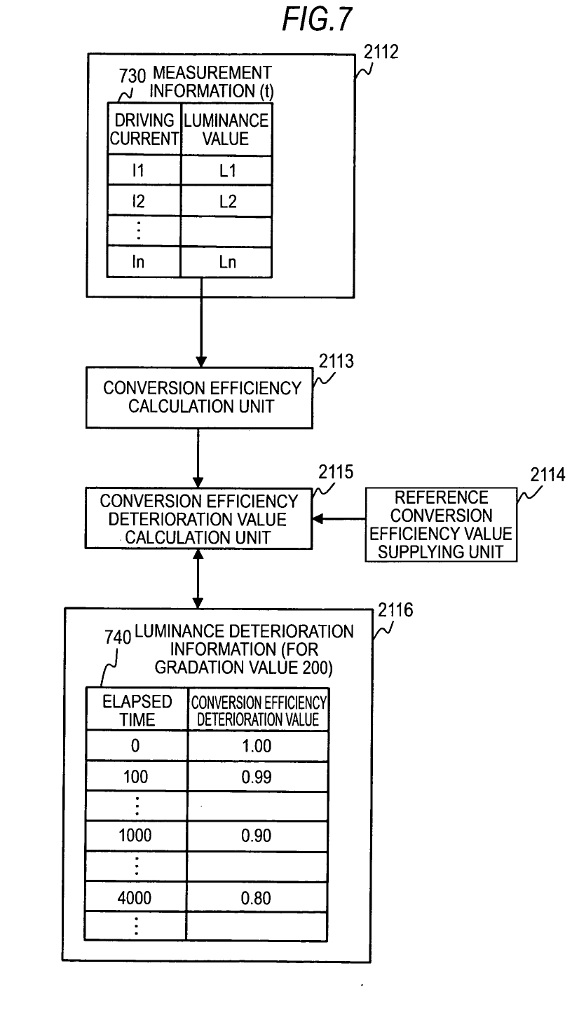

FIG. 7 is a diagram showing a generation example of the luminance deterioration information by the luminance deterioration information generation unit. FIG. 7 schematically illustrates the flow up to when the luminance deterioration information (for the gradation value 200) 740 is held in the luminance deterioration information holding unit 2116 based on the measurement information 730 held in the measurement information holding unit 2112. In this example, a case where the luminance deterioration information when the pixel circuit 609 is driven with a gradation value capable of obtaining a luminance of 200 nit in the initial state is generated will be described. In the following description, this gradation value will be denoted by “gradation value 200”. In addition, the conversion efficiency value in the initial state serving as the reference of correction before the process begins is supplied to the reference conversion efficiency value supplying unit 2114. Moreover, the “gradation value 200” is output to the pixel circuit 609. The “gradation value 200” is output to the pixel circuit 609 excluding a luminance measurement period which occurs every prescribed cycle. In this way, it is possible to measure the degree of deterioration of the pixel circuit 609 at “gradation value 200”.

In the measurement information holding unit 2112, a plurality of levels of deviation correction section and the luminance values when the driving current is output to the pixel circuit 609, measured by the luminance measuring unit 2111 after the elapse of “t” period (“t” is an optional positive value) from the initial state are held in a correlated manner. The luminance measuring unit 2111 measures the luminance values while changing the driving current in n steps in a manner of I1, I2, . . . , In and supplies the measured luminance values to the measurement information holding unit 2112 as the measurement information (t) 730. For example, luminance values L1, L2, and Ln are measured for the driving current I1, I2, and In, respectively.

The conversion efficiency calculation unit 2113 reads the measurement information (t) 730 from the measurement information holding unit 2112 and calculates a conversion efficiency value of the pixel circuit 609 when “t” period has been elapsed from the initial state. For example, the conversion efficiency calculation unit 2113 calculates the slope of the variation of the luminance value in relation to the variation of the driving current between levels to thereby calculate the conversion efficiency value. The calculated conversion efficiency value is supplied to the conversion efficiency deterioration value calculation unit 2115.

The conversion efficiency deterioration value calculation unit 2115 calculates the conversion efficiency deterioration value from the conversion efficiency value after the elapse of “t” period from the initial state, supplied from the conversion efficiency calculation unit 2113 and the reference conversion efficiency value in the initial state supplied from the reference conversion efficiency value supplying unit 2114. For example, the conversion efficiency deterioration value calculation unit 2115 calculates the conversion efficiency deterioration value using Equation (4). Moreover, the conversion efficiency deterioration value calculation unit 2115 updates the luminance deterioration information (for the gradation value 200) 740 held by the luminance deterioration information holding unit 2116 using the calculated conversion efficiency deterioration value. According to the simplest updating method, when the “t” period elapsed from the initial state is “100” and the calculated conversion efficiency deterioration value is “0.99”, the luminance deterioration information is replaced with a conversion efficiency deterioration value “0.99” corresponding to the elapsed time “100” in the luminance deterioration information (for the gradation value 200) 740.

In this way, the luminance deterioration information is updated in accordance with the actual measurement values.

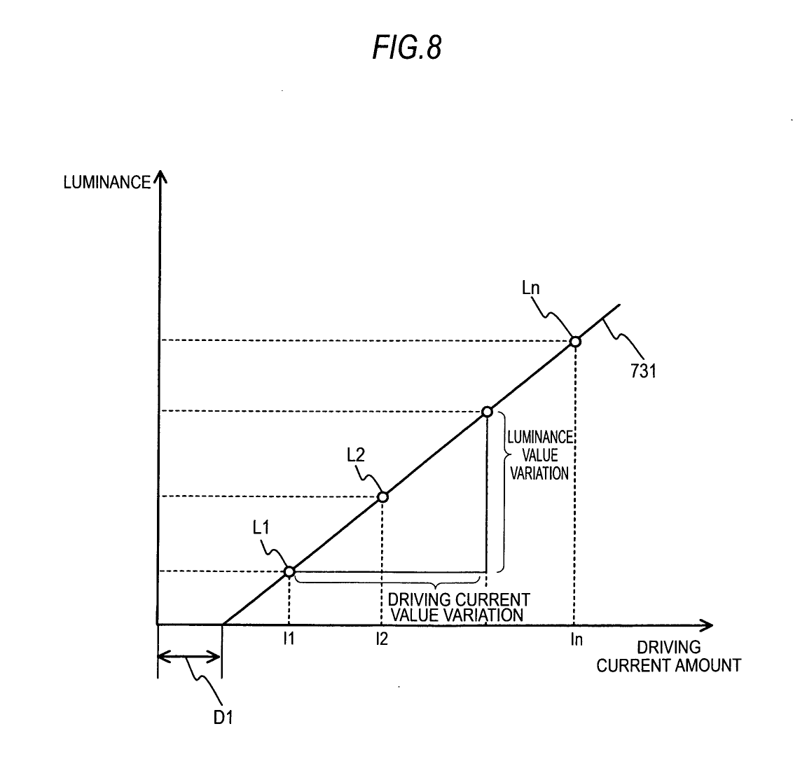

Here, the measurement information will be described. FIG. 8 is a graph showing an example of a pixel characteristic based on the measurement information. The horizontal axis of FIG. 8 represents the magnitude of a driving current corresponding to the gradation value output by the luminance measuring unit 2111, and the vertical axis represents the value (luminance value) of the emission luminance measured by the luminance measuring unit 2111.

In the example of FIG. 8, the luminance values L1, L2, . . . , and Ln corresponding to the driving current I1, I2, . . . , and In are plotted. A pixel characteristic 731 is one which connects the plotted measurement data and represents the relationship between an input gradation value (driving current) and a luminance value of the pixel circuit 609 when “t” period has been elapsed from the initial state. As is clear from Equation (2), the driving current amount decrease component D1 is commonly included in the driving current I1, I2, . . . , and In when light is emitted with the luminance values L1, L2, . . . , and Ln. Thus, by calculating the slope of the pixel characteristic 731 which plots the change of the luminance value with respect to the driving current value, it is possible to calculate an accurate conversion efficiency value excluding the driving current amount decrease component D1.

In addition, the driving current amount decrease component D1 may be calculated from the pixel characteristic 731 and may be used for calculation of the decrease amount coefficient by the current deterioration correction pattern generation unit 213.

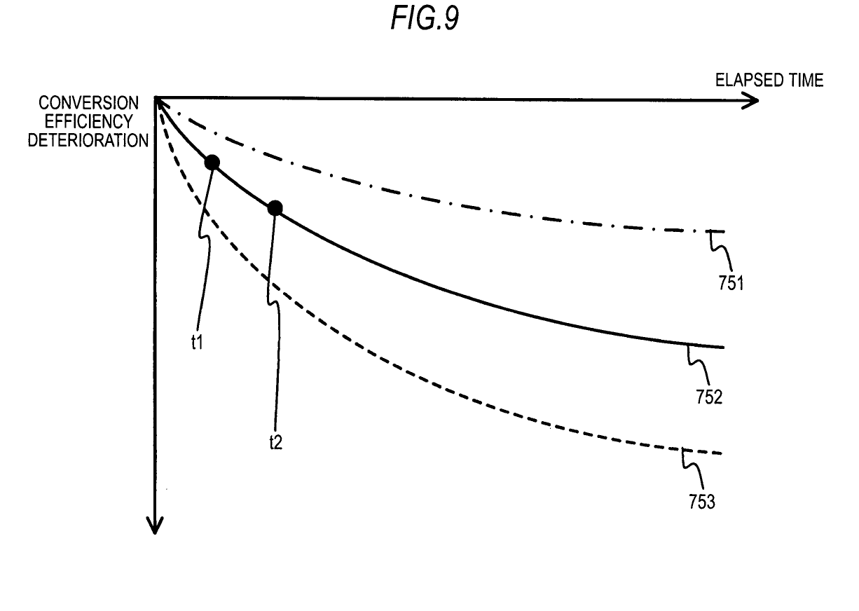

Next, the luminance deterioration information will be described. FIG. 9 is a graph showing an example of the luminance deterioration curve based on the luminance deterioration information. The horizontal axis of FIG. 9 represents the elapsed time from the initial state when the pixel circuit 609 is driven, the vertical axis represents the conversion efficiency deterioration calculated by the conversion efficiency deterioration value calculation unit 2115.

A luminance deterioration curve (for the gradation value 100) 751 shows the relationship between the elapsed time and the deterioration information when the pixel circuit 609 is driven with the gradation value of 100. The gradation value 100 is a gradation value for causing the pixel circuit 609 in the initial state to emit light at 100 nit.

A luminance deterioration curve (for the gradation value 200) 752 shows the relationship between the elapsed time and the deterioration information when the pixel circuit 609 is driven with the gradation value of 200. The gradation value 200 is a gradation value for causing the pixel circuit 609 in the initial state to emit light at 200 nit.

A luminance deterioration curve (for the gradation value 400) 753 shows the relationship between the elapsed time and the deterioration information when the pixel circuit 609 is driven with the gradation value of 400. The gradation value 400 is a gradation value for causing the pixel circuit 609 in the initial state to emit light at 400 nit.

For example, as described in the luminance deterioration information generation process shown in FIG. 7, when generating the luminance deterioration information for the gradation value 200, the conversion efficiency deterioration value calculation unit 2115 calculates the conversion efficiency deterioration values at the elapse time t1, t2, . . . , and the like. The conversion efficiency deterioration values are based on measurement data actually measured for the pixel circuit 609 by the generation process shown in FIG. 7. Thus, by correcting the luminance deterioration curve (for the gradation value 200) 752 using the conversion efficiency deterioration values calculated at the elapsed time t1, t2, . . . , and the like, it is possible to obtain an accurate luminance deterioration curve matching the actual operation state for the display device 100.

In addition, the luminance deterioration curve (for the gradation value 100) 751, the luminance deterioration curve (for the gradation value 200) 752, and the luminance deterioration curve (for the gradation value 400) 753 have correlation. For example, the time required for the conversion efficiency deterioration value at “gradation value 200” to deteriorate by a prescribed proportion (for example, 10 percent) has proportional relationship with the time required for 10 percents of the conversion efficiency deterioration value at “gradation value 100” to deteriorate similarly by the prescribed proportion. Thus, by holding the luminance deterioration curve (for the gradation value 200) 752 in the luminance deterioration information holding unit 2116, it is possible to calculate the conversion efficiency deterioration values of the other luminance deterioration curves.

Next, a generation example of a conversion efficiency deterioration correction pattern, performed by the conversion efficiency deterioration correction pattern generation unit 212 based on the luminance deterioration information held by the luminance deterioration information holding unit 2116 will be described.

### [Generation Example of Conversion Efficiency Deterioration Correction Pattern]

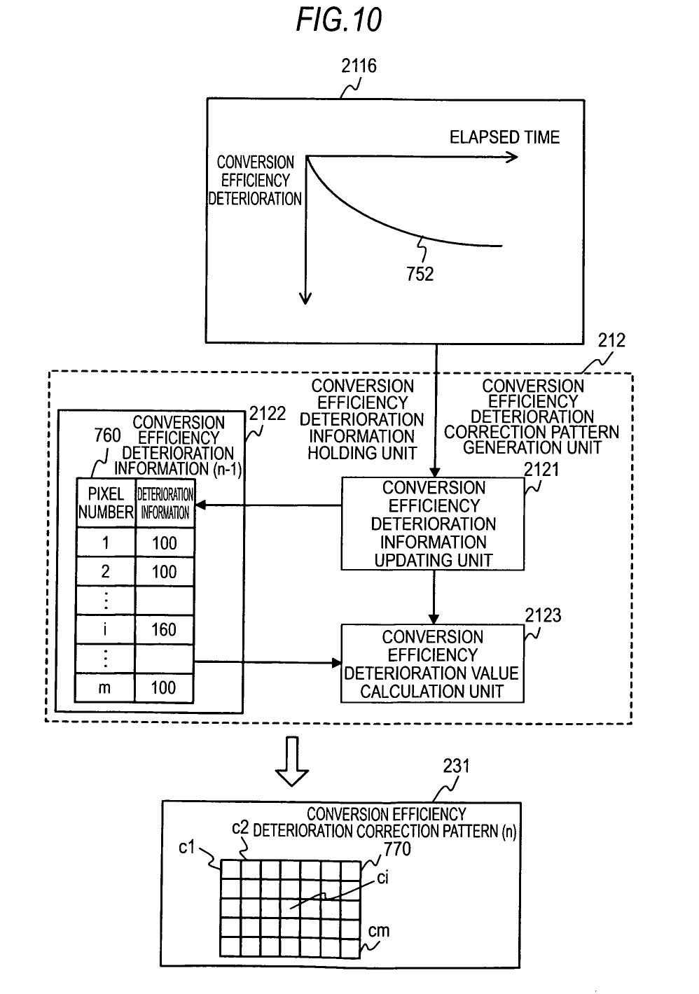

FIG. 10 is a diagram showing a generation of a conversion efficiency deterioration correction pattern. FIG. 10 schematically illustrates the flow up to when a conversion efficiency deterioration correction pattern (n) 770 held by the conversion efficiency deterioration correction pattern holding unit 231 is generated using the luminance deterioration curve (for the gradation value 200) 752 based on the luminance deterioration information 740 held by the luminance deterioration information holding unit 2116. In addition, for the sake of convenience, pixel circuits provided in the display device 100 are identified by 1 to m. Here, the conversion efficiency deterioration correction pattern can be generated at the same cycle as, or a longer cycle than, the processing cycle at which the correction computation unit 220 processes a video signal. This is because deterioration progresses slowly even when the luminance fluctuates from one pixel circuit to another. For example, the amount of computation by the burn-in correction unit 200 can be decreased by updating the conversion efficiency deterioration correction pattern every one hour. However, in the following description, a case in which the conversion efficiency deterioration correction pattern is updated whenever the gradation value of a corrected video signal is output to a pixel circuit will be described.

The luminance deterioration information (for the gradation value 200) 740 representing the luminance deterioration curve (for the gradation value 200) 752 is held in the luminance deterioration information holding unit 2116. The conversion efficiency deterioration values are held in the luminance deterioration information (for the gradation value 200) 740 so as to be correlated with the elapsed time from the initial state when the measurement target pixel circuit 609 is driven with the gradation value 200.

The conversion efficiency deterioration correction pattern generation unit 212 includes a conversion efficiency deterioration information updating unit 2121, a conversion efficiency deterioration information holding unit 2122, and a conversion efficiency deterioration value calculation unit 2123. In this example, it is assumed that the conversion efficiency deterioration correction pattern is updated by acquiring the video signal corrected by the correction computation unit 220 every one minute.

The conversion efficiency deterioration information updating unit 2121 updates the conversion efficiency deterioration information held in the conversion efficiency deterioration information holding unit 2122 by adding, to the same, a new deterioration amount of the conversion efficiency of each of the pixel circuits 1 to m. Here, the conversion efficiency deterioration information is, for example, a value obtained by converting the amount of the conversion efficiency deterioration of each of the pixel circuits 1 to m into an emission period at a specific gradation value. The converted value corresponds to an emission period taken up to the occurrence of deterioration equivalent to the amount of deterioration of the conversion efficiency when the pixel circuit is caused to emit light with the specific gradation value. For example, the conversion efficiency deterioration information updating unit 2121 calculates new information on deterioration of the conversion efficiency of each of the pixel circuits 1 to m using an efficiency deterioration conversion coefficient based on the corrected video signal supplied from the correction computation unit 220. Here, the efficiency deterioration conversion coefficient is a coefficient for calculating the deterioration amount of the conversion efficiency of the light-emitting device 640 with the elapse of time based on an emission period and the gradation during emission. The efficiency deterioration conversion coefficient can be calculated based on the luminance deterioration information (for the gradation value 200) held by the luminance deterioration information holding unit 2116. Moreover, the conversion efficiency deterioration values of the pixel circuits 1 to m can be obtained using the efficiency deterioration conversion coefficient based on the gradation value of the corrected video signal and the deterioration amount of the conversion efficiency obtained by converting the deterioration amount of the pixel circuit set in the conversion efficiency deterioration information (n−1) 760 into an emission period corresponding to the specific gradation value (gradation value 200). For example, the deterioration amount corresponding to an emission period set in the current amount deterioration characteristic information (n−1) 760 is calculated based on the elapsed time up to the deterioration amount calculation time from the emission starting time on the luminance deterioration curve (for the gradation value 200) 752 and the gradation value output during the elapsed time. The conversion efficiency deterioration information updating unit 2121 updates the current amount deterioration characteristic information (n−1) 760 held in the conversion efficiency deterioration information holding unit 2122 by adding the calculated new deterioration amounts of the pixel circuits 1 to m to the value of the deterioration information of the corresponding pixel number in the conversion efficiency deterioration information (n−1) 760.

The conversion efficiency deterioration information holding unit 2122 holds, for each pixel circuit, the conversion efficiency deterioration information regarding deterioration of the luminance conversion efficiency of the pixel circuit 1 to m, supplied by the conversion efficiency deterioration information updating unit 2121.

In the conversion efficiency deterioration information (n−1) 760 of FIG. 10, a conversion efficiency deterioration value based on the display at the (n−1)-th update period is held. The conversion efficiency deterioration information (n−1) 760 is used for generating the conversion efficiency deterioration correction pattern (n) 770 for correcting the display at the present (n-th) update period. A pixel number which is the number of a pixel circuit is held in the left column of the conversion efficiency deterioration information (n−1) 760, and the conversion efficiency deterioration information (the deterioration information) of the pixel circuit is held in the right column. For example, in this example, the conversion efficiency deterioration value is a value converted into the emission period (elapsed time) with the gradation value 200. For example, a period of “160” is held as the conversion efficiency deterioration information corresponding to the pixel number “i”, and a period of “100” is held as the conversion efficiency deterioration information corresponding to the pixels numbers “1”, “2”, and “m”.

In a state where such conversion efficiency deterioration information (n−1) 760 is held in the conversion efficiency deterioration information holding unit 2122, the conversion efficiency deterioration value calculation unit 2123 updates the n-th conversion efficiency deterioration correction pattern. First, the conversion efficiency deterioration information of a pixel circuit serving as a correction target is acquired, and the conversion efficiency of the pixel circuit is calculated. The calculated efficiency coefficient is supplied to the conversion efficiency deterioration value calculation unit 2123 as a target conversion efficiency value. For example, the process in which the target conversion efficiency value for the pixel number “1” is supplied to the conversion efficiency deterioration value calculation unit 2123 will be described. First, the conversion efficiency deterioration information updating unit 2121 acquires the deterioration information “100” for the pixel number “1” from the conversion efficiency deterioration information (n−1) 760 and calculates the conversion efficiency using the coefficient conversion information. It is assumed that the coefficient conversion information is held in advance. Moreover, the conversion efficiency deterioration information updating unit 2121 calculates the conversion efficiency deterioration value of the pixel circuit from the calculated conversion efficiency of the pixel circuit of the pixel number “1” and a reference efficiency deterioration value serving as a reference of correction and supplies the calculated conversion efficiency deterioration value to the conversion efficiency deterioration correction pattern holding unit 231. In this way, a conversion efficiency deterioration value corresponding to a conversion efficiency deterioration value “c1” of the conversion efficiency deterioration correction pattern (n) is held in the conversion efficiency deterioration correction pattern holding unit 231.

Next, the conversion efficiency deterioration correction pattern (n) 770 generated by the correction pattern generation unit 210 and held in the conversion efficiency deterioration correction pattern holding unit 231 in this way will be described.

The conversion efficiency deterioration correction pattern (n) 770 schematically shows a conversion efficiency deterioration correction pattern generated by the conversion efficiency deterioration value calculation unit 2123. FIG. 10 schematically shows an example of a conversion efficiency deterioration pattern when a conversion efficiency deterioration value for each pixel circuit, generated by the conversion efficiency deterioration value calculation unit 2123 is arranged so as to correspond to an arrangement of pixels constituting a display screen. Specifically, the conversion efficiency deterioration correction pattern (n) 770 is an example of a correction pattern including the conversion efficiency deterioration values generated based on the conversion efficiency deterioration information (n−1) 760 and is a correction pattern for correcting the gradation value of a video signal of each frame displayed during the n-th one minute period.

The conversion efficiency deterioration value c1 in the conversion efficiency deterioration correction pattern (n) 770 is a conversion efficiency deterioration value for correcting a pixel circuit corresponding to a pixel number “1” shown in the conversion efficiency deterioration information (n−1) 760. Moreover, similarly to the conversion efficiency deterioration value c1, the conversion efficiency deterioration values c2, ci, and cm are conversion efficiency deterioration values for correcting the gradation value of a video signal supplied to the pixel circuits corresponding to the pixel numbers “2”, “i”, and “m” shown in the conversion efficiency deterioration information (n−1) 760. In the correction computation unit 220, the gradation value of a video signal is corrected based on the conversion efficiency deterioration correction pattern (n) 770.

For example, it is assumed that the conversion efficiency deterioration value ci of a pixel circuit corresponding to the pixel number “i” is larger than the conversion efficiency deterioration values c1, c2, and cm of pixel circuits corresponding to the other pixels numbers “1”, “2”, and “m”. In this case, the correction computation unit 220 sets the correction amount (increment) of the gradation value of a video signal of a pixel circuit corresponding to the pixel number “i” so as to be larger than the correction amount (increment) of the gradation value of a video signal of pixel circuits corresponding to the other pixel numbers “1”, “2”, and “m”. By correcting the gradation value in this way, it is possible to correct burn-in.

As above, since the conversion efficiency deterioration correction pattern is calculated based on the actually measured deterioration state of the pixel circuit, it is possible to correct burn-in with high accuracy.

### [Operation Example of Luminance Deterioration Information Generation Unit]

Next, the operation of the luminance deterioration information generation unit 211 of the burn-in correction unit 200 will be described. FIG. 11 is a flowchart showing an example of the procedure of a luminance deterioration information generation process.

The luminance deterioration information generation process starts every prescribed cycle. Since the deterioration of a pixel circuit progresses slowly, the process may be executed at a long cycle, for example, every one day or ten days.

### [Step S01]

The luminance measuring unit 2111 starts measuring the luminance of a measurement target dummy pixel circuit. An initial value (=1) is set to a pointer k indicating the measuring gradation value.

### [Step S02]

The luminance measuring unit 2111 outputs a gradation value (k) indicated by the pointer to the dummy pixel circuit. It is assumed that a driving current corresponding to the gradation value (k) is known.

### [Step S03]

The luminance measuring unit 2111 measures the luminance of the dummy pixel circuit to which the gradation value (k) is output in step S02. The measured luminance value is supplied to the measurement information holding unit 2112 so as to be correlated with a driving current corresponding to the gradation value (k).

### [Step S04]

The luminance measuring unit 2111 adds “1” to the pointer in order to output the next gradation value.

### [Step S05]

The luminance measuring unit 2111 checks the pointer to determine whether the luminance measurement has been finished with respect to all gradation values. When the measurement has been finished, the process proceeds to step S06. When the measurement has not been finished, the process proceeds to step S02, and the luminance measurement is performed with the next gradation value.

### [Step S06]

The luminance measuring unit 2111 outputs the original gradation value which was set to the dummy pixel circuit before the luminance measurement starts.

### [Step S07]

The conversion efficiency calculation unit 2113 calculates the variation (ΔSlope) of the luminance value corresponding to the variation of the driving current based on the measurement information held by the measurement information holding unit 2112. The calculated ΔSlope is supplied to the conversion efficiency deterioration value calculation unit 2115 as the conversion efficiency value.

### [Step S08]

The conversion efficiency deterioration value calculation unit 2115 calculates the conversion efficiency deterioration value representing the degree of deterioration of the conversion efficiency of the dummy pixel circuit based on the present conversion efficiency value of the dummy pixel circuit calculated by the conversion efficiency calculation unit 2113 and the conversion efficiency value in the initial state of the dummy pixel circuit.

### [Step S09]

The conversion efficiency deterioration value calculation unit 2115 updates the luminance deterioration information using the calculated conversion efficiency deterioration value.

By executing the above processing procedure, it is possible to generate the luminance deterioration information based on the degree of deterioration measured for an actual pixel circuit. Since the luminance deterioration information is based on the measurement values of the dummy pixel circuit, it is possible to obtain accurate luminance deterioration information of a pixel circuit to be subjected to burn-in correction. Moreover, by performing burn-in correction using the luminance deterioration information, it is possible to perform the burn-in correction with high accuracy.

The display device 100 described can be applied to a display which has a flat panel shape and is included in any of various kinds of electronic apparatus such as, for example, a digital camera, a notebook personal computer, a cellular phone, or a video camcorder. Specifically, the display device can be applied to a display of electronic apparatus in any field, capable of displaying a video signal input to the electronic apparatus or generated in the electronic apparatus as an image or a video. Examples of an electronic apparatus to which such a display device 100 is applied will be described below.

### [Application Example to Electronic Apparatus]

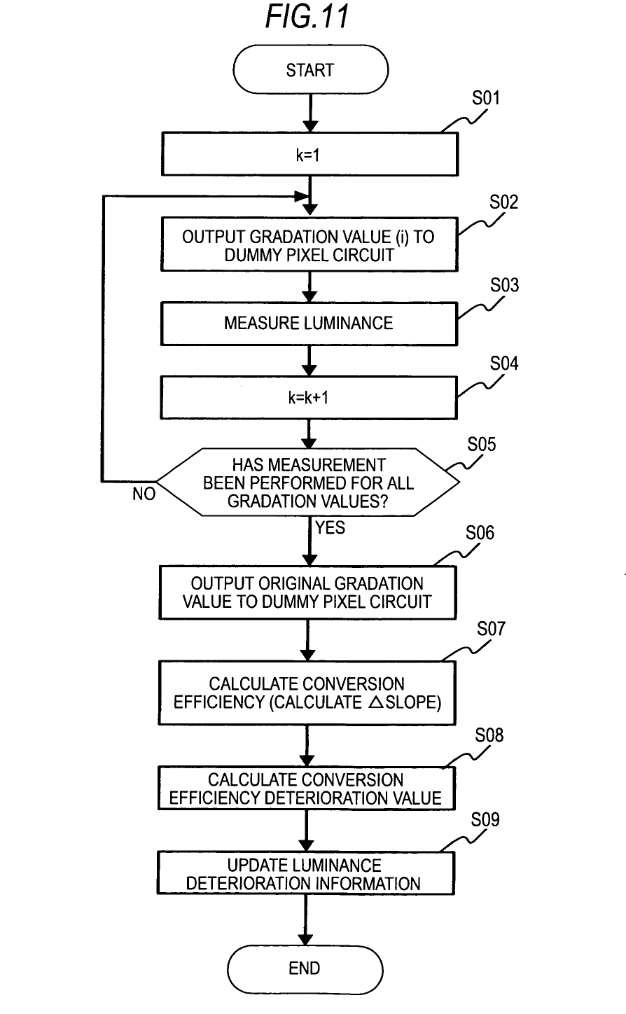

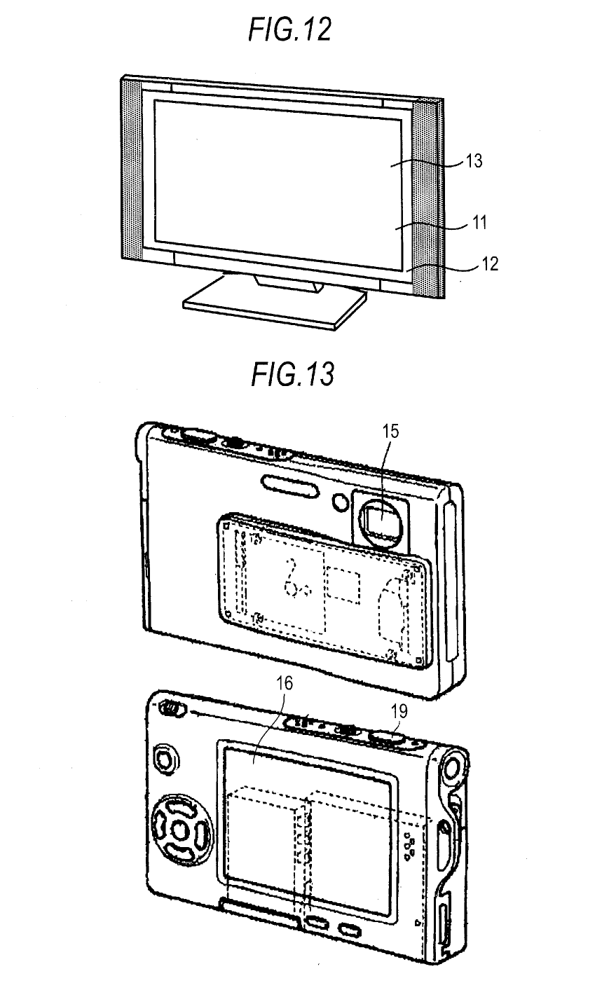

FIG. 12 is a perspective view showing a television set including the display device according to the embodiment of the present disclosure. The television set shown in FIG. 12 includes a video display screen 11 including a front panel 12, a filter glass 13, and the like, and is manufactured by using the display device 100 as the video display screen 11.

FIG. 13 is a perspective view showing a digital camera including the display device according to the embodiment of the present disclosure. In FIG. 13, the front view of the digital still camera is shown on the upper part, and the rear view of the digital still camera is shown on the lower part. The digital still camera shown in FIG. 13 includes an imaging lens, a flash light emitter 15, a display unit 16, a control switch, a menu switch, a shutter button 19, and the like, and is manufactured by using the display device 100 as the display unit 16.

FIG. 14 is a perspective view showing a notebook personal computer including the display device according to the embodiment of the present disclosure. The notebook personal computer shown in FIG. 14 includes a main body 20, a keyboard 21 that is included in the main body 20 and operated when inputting characters and the like, and a display unit 22 which is included in a main body cover so as to display an image. The notebook personal computer is manufactured by using the display device 100 as the display unit 22.

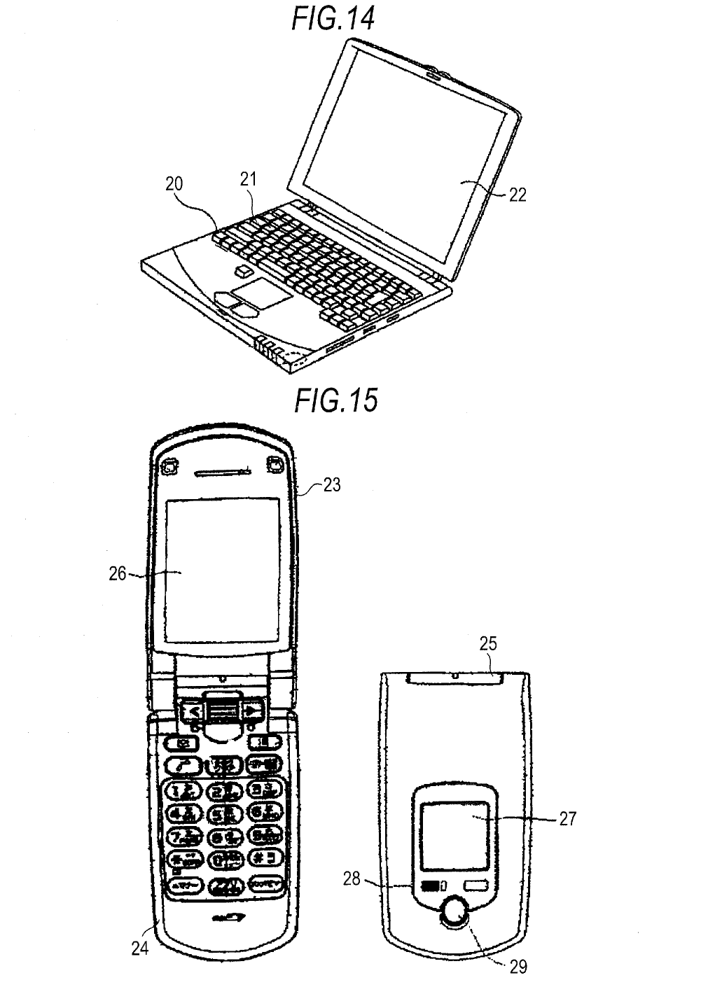

FIG. 15 is a schematic view showing a portable terminal including the display device according to the embodiment of the present disclosure. In FIG. 15, the open state of the portable terminal is shown on the left side, and the closed state of the portable terminal is shown on the right side. The portable terminal shown in FIG. 15 includes an upper housing 23, a lower housing 24, a connecting portion (in this example, a hinge) 25, a display 26, a sub-display 27, a picture light 28, a camera 29, and the like. The portable terminal is manufactured by using the display device 100 as the display 26 or the sub-display 27.

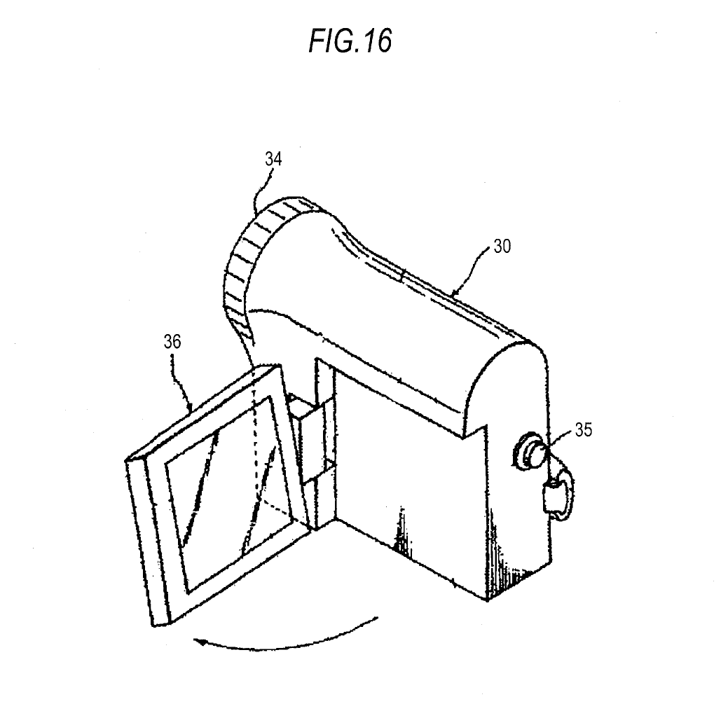

FIG. 16 is a perspective view showing a video camera including the display device according to the embodiment of the present disclosure. The video camera shown in FIG. 16 includes a main body portion 30, a lens 34 that is disposed on a side surface facing the front side and used for photographing a subject, a switch 35 for starting and stopping imaging, a monitor 36, and the like. The video camera is manufactured by using the display device 100 as the monitor 36.

According to the electronic apparatuses described above, since deterioration components of conversion efficiency, in particular, can be obtained with high accuracy, it is possible to resolve burn-in with high accuracy.

The processing functions described above can be realized by a computer. In this case, a program describing the processing content of functions which are to be included in a signal processing device, a display device, and an electronic apparatus is provided. When the program is executed by a computer, the processing functions are realized on the computer. The program describing the processing content may be recorded on a computer-readable recording medium. Examples of the computer-readable recording medium include a magnetic storage device, an optical disc, an opto-magnetic recording medium, and a semiconductor memory. Examples of the magnetic storage device include a hard disk device (HDD), a flexible disk (FD), and a magnetic tape. Examples of the optical disc include a DVD, a DVD-RAM, a CD-ROM/RW. Examples of the opto-magnetic recording medium include a MO (Magneto-Optical disc).

When distributing the program, for example, a portable recording medium such as a DVD or a CD-ROM in which the program is recorded is sold. Moreover, the program may be stored in a storage device of a server computer so that the program can be transmitted from the server computer to another computer through a network.

The computer executing the program stores, for example, the program recorded on a portable recording medium or the program transmitted from the server computer in a subject storage device. Then, the computer reads the program from the subject storage device and executes processes in accordance with the program. In addition, the computer may read the program directly from a portable recording medium and execute processes in accordance with the program. Moreover, the computer may sequentially execute processes in accordance with the received program whenever the program is transmitted from the server computer connected through a network.

Moreover, at least part of the processing functions described above may be realized by an electronic circuit such as a DSP (Digital Signal Processor), an ASIC, or a PLD (Programmable Logic Device).

The present disclosure contains subject matter related to that disclosed in Japanese Priority Patent Application JP 2010-291841 filed in the Japan Patent Office on Dec. 28, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a measuring unit that outputs a plurality of levels of driving signals having different magnitudes every prescribed update period to drive a prescribed pixel circuit with driving current values corresponding to the respective levels of driving signals and measures the luminance of the prescribed pixel circuit when driven with each of the driving current values;
a conversion efficiency calculation unit that calculates a conversion efficiency value of the prescribed pixel circuit based on the relationship between a driving current value corresponding to the level of the driving signal and the luminance value of the prescribed pixel circuit; and
a conversion efficiency deterioration value calculation unit that compares the conversion efficiency value of the prescribed pixel circuit with a conversion efficiency value when the prescribed pixel circuit is a correction reference state, calculates a conversion efficiency deterioration value corresponding to an elapsed time from the time when the prescribed pixel circuit is in the correction reference state, and updates luminance deterioration information with the conversion efficiency deterioration value, the luminance deterioration information representing the relationship between the elapsed time from the time when the prescribed pixel circuit is in the correction reference state and the conversion efficiency deterioration value of the prescribed pixel circuit.

2. The signal processing device according to claim 1,
wherein the conversion efficiency calculation unit calculates the conversion efficiency value from the relationship between a variation of a driving current value between different levels of the driving signal and a variation of a luminance value corresponding to the variation of the driving current value based on the driving current value and the luminance value of the prescribed pixel circuit, obtained from the plurality of levels of driving signals by the measuring unit.

3. The signal processing device according to claim 1, further comprising a luminance deterioration information holding unit that holds luminance deterioration information on the prescribed pixel circuit, which is generated in advance,
wherein the conversion efficiency deterioration value calculation unit corrects the luminance deterioration information held in the luminance deterioration information holding unit in accordance with the calculated conversion efficiency deterioration value based on the calculated conversion efficiency deterioration value to thereby update the luminance deterioration information.

4. The signal processing device according to claim 1, further comprising a dummy pixel circuit which can be driven by setting a driving signal of an optional magnitude thereto,
wherein the measuring unit uses the dummy pixel circuit as the prescribed pixel circuit.

5. A signal processing method comprising:
outputting a plurality of levels of driving signals having different magnitudes every prescribed update period to drive a prescribed pixel circuit with driving current values corresponding to the respective levels of driving signals and measuring the luminance of the prescribed pixel circuit when driven with each of the driving current values;
calculating a conversion efficiency value of the prescribed pixel circuit based on the relationship between a driving current value corresponding to the level of the driving signal and the luminance value of the prescribed pixel circuit; and
comparing the conversion efficiency value of the prescribed pixel circuit with a conversion efficiency value when the prescribed pixel circuit is a correction reference state to calculate a conversion efficiency deterioration value corresponding to an elapsed time from the time when the prescribed pixel circuit is in the correction reference state, and updating luminance deterioration information with the conversion efficiency deterioration value, the luminance deterioration information representing the relationship between the elapsed time from the time when the prescribed pixel circuit is in the correction reference state and the conversion efficiency deterioration value of the prescribed pixel circuit.

6. A signal processing method comprising:
measuring a luminance of a prescribed pixel circuit every prescribed update period when the pixel circuit is driven with a plurality of different levels of driving current values;
calculating a conversion efficiency value of the prescribed pixel circuit based on the relationship between the driving current value and the luminance value of the prescribed pixel circuit; and
comparing the conversion efficiency value with a conversion efficiency value in a reference state of the prescribed pixel circuit to thereby calculate a conversion efficiency deterioration value corresponding to an elapsed time from the reference state of the prescribed pixel circuit and updating luminance deterioration information with the conversion efficiency deterioration value, the luminance deterioration information representing the relationship between the elapsed time and the conversion efficiency deterioration value of the prescribed pixel circuit.

7. A display device comprising:
a plurality of pixel circuits each having a light-emitting device that emits light in accordance with a gradation value of a video signal;
a measuring unit that outputs a plurality of levels of driving signals having different magnitudes every prescribed update period to drive a prescribed pixel circuit with driving current values corresponding to the respective levels of driving signals and measures the luminance of the prescribed pixel circuit when driven with each of the driving current values;
a conversion efficiency calculation unit that calculates a conversion efficiency value of the prescribed pixel circuit based on the relationship between a driving current value corresponding to the level of the driving signal and the luminance value of the prescribed pixel circuit;
a conversion efficiency deterioration value calculation unit that compares the conversion efficiency value of the prescribed pixel circuit with a conversion efficiency value when the prescribed pixel circuit is a correction reference state, calculates a conversion efficiency deterioration value corresponding to an elapsed time from the time when the prescribed pixel circuit is in the correction reference state, and updates luminance deterioration information with the conversion efficiency deterioration value, the luminance deterioration information representing the relationship between the elapsed time from the time when the prescribed pixel circuit is in the correction reference state and the conversion efficiency deterioration value of the prescribed pixel circuit; and
a correction computation unit that calculates a conversion efficiency deterioration amount of each of the plurality of pixel circuits based on the luminance deterioration information, generates a conversion efficiency deterioration correction pattern for correcting the gradation value of the video signal in accordance with the conversion efficiency deterioration amount of the pixel circuit, corrects the gradation value of the video signal of the pixel circuit using the conversion efficiency deterioration correction pattern generated for each of the pixel circuits, and outputs the corrected gradation value to the pixel circuit.

8. An electronic apparatus comprising:
a plurality of pixel circuits each having a light-emitting device that emits light in accordance with a gradation value of a video signal;
a measuring unit that outputs a plurality of levels of driving signals having different magnitudes every prescribed update period to drive a prescribed pixel circuit with driving current values corresponding to the respective levels of driving signals and measures the luminance of the prescribed pixel circuit when driven with each of the driving current values;
a conversion efficiency calculation unit that calculates a conversion efficiency value of the prescribed pixel circuit based on the relationship between a driving current value corresponding to the level of the driving signal and the luminance value of the prescribed pixel circuit;
a conversion efficiency deterioration value calculation unit that compares the conversion efficiency value of the prescribed pixel circuit with a conversion efficiency value when the prescribed pixel circuit is a correction reference state, calculates a conversion efficiency deterioration value corresponding to an elapsed time from the time when the prescribed pixel circuit is in the correction reference state, and updates luminance deterioration information with the conversion efficiency deterioration value, the luminance deterioration information representing the relationship between the elapsed time from the time when the prescribed pixel circuit is in the correction reference state and the conversion efficiency deterioration value of the prescribed pixel circuit; and
a correction computation unit that calculates a conversion efficiency deterioration amount of each of the plurality of pixel circuits based on the luminance deterioration information, generates a conversion efficiency deterioration correction pattern for correcting the gradation value of the video signal in accordance with the conversion efficiency deterioration amount, corrects the gradation value of the video signal of the pixel circuit using the conversion efficiency deterioration correction pattern generated for each of the pixel circuits, and outputs the corrected gradation value to the pixel circuit.
